(19) United States
(12) Patent Application Publication
(10) Pub. No.: US 2026/0257632 A1
(43) Pub. Date: Sep. 3, 2026

(54) SUPPORT STRUCTURE FOR VEHICLE BATTERY WIRE HARNESS

(71) Applicant: Nissan Motor Co., Ltd., Yokohama-shi (JP)

(72) Inventor: Tsuguhiro KAWASAKI, Kanagawa (JP)

(21) Appl. No.: 19/550,770

(22) Filed: Feb. 26, 2026

(30) Foreign Application Priority Data
Feb. 28, 2025 (JP) 2025-031792

(51) Int. Cl. B60R 16/02; B60R 16/033; H02G 3/32

(52) U.S. Cl. CPC B60R 16/0215; B60R 16/033; H02G 3/32

(57) ABSTRACT

A support structure is provided for a vehicle battery wire harness to suppress an excessive load acting on the battery wire harness. The support structure includes a drive motor, a battery, a wire harness, and a support member. The battery supplies power to the drive motor. The wire harness supplies the power from the battery to the drive motor. The support member secures the wire harness to at least one of the battery, the drive motor, and a part of a vehicle other than these. The bending strength of the support member against an input in the vehicle width direction is set smaller than the tensile strength of the wire harness.

### CROSS REFERENCE TO RELATED APPLICATIONS

This application claims priority under 35 U.S.C. § 119 to Japanese Patent Application No. 2025-031792 filed on Feb. 28, 2025, the entire disclosure of Japanese Patent Application No. 2025-031792 is hereby incorporated herein by reference.

### BACKGROUND

### Technical Field

The present invention relates to a support structure for a vehicle battery wire harness.

### Background Information

One known support structure of this type for a battery wire harness involves routing the harness connected to a high-voltage battery and an electric compressor from the high-voltage battery above the lower portion of a power control unit toward a transaxle, then pulling it out to one side of the power control unit, inserting it into a cross member through a hole formed in the cross member at a position on one side of the center in the vehicle width direction, passing it through the cross member, and pulling it out through a hole formed in the cross member at a position on the other side of the center in the vehicle width direction to connect to the electric compressor (Japanese Patent No. 7374550).

With the above conventional support structure for a battery wire harness, however, the harness connecting the transaxle, power control unit, and high-voltage battery is routed over the shortest distance possible, so if these transaxle, power control unit, and high-voltage battery move away from each other in the event of a side collision, an excessive load may possibly be placed on the wire harness.

### SUMMARY

A problem to be solved by the present invention is to provide a support structure for a vehicle battery wire harness that can suppress an excessive load acting on the battery wire harness.

The present invention solves the above problem in a support structure for a vehicle battery wire harness, comprising: a battery that supplies power to a drive motor; and a wire harness that supplies the power from the battery to the drive motor, by setting the bending strength of a support member, which secures the wire harness to at least one of the battery, the drive motor, or a part of a vehicle other than these battery and drive motor, against an input in a vehicle width direction smaller than a tensile strength of the wire harness.

According to the present invention, it is possible to suppress an excessive load acting on the battery wire harness.

### BRIEF DESCRIPTION OF DRAWINGS

Referring now to the attached drawings which form a part of this original disclosure, illustrated embodiments are shown.

FIG. 1 is a bottom view of a vehicle illustrating an embodiment of the support structure for a battery wire harness according to the present invention;

FIG. 2 is a plan view illustrating an embodiment of the support structure for a battery wire harness according to the present invention;

FIG. 3 is a plan view illustrating a state in which the battery and drive motor have moved relatively in the vehicle width direction from the state illustrated in FIG. 2;

FIG. 4A is a perspective view illustrating an embodiment of a support member according to the present invention, and FIG. 4B is a side view;

FIG. 5A is a perspective view illustrating an example of a band for securing a wire harness to the support member of FIGS. 4A and 4B, and FIG. 5B is an exploded perspective view;

FIGS. 6A to 6C are perspective views illustrating other embodiments of a support member according to the present invention;

FIG. 7A is a plan view illustrating still another embodiment of a support member according to the present invention, and FIG. 7B is a perspective view illustrating the band;

FIG. 8 is a plan view illustrating another embodiment of the support structure for a battery wire harness according to the present invention;

FIG. 9 is a side view for describing a movable range of the support member of FIG. 8;

FIG. 10 is a plan view illustrating a state in which the battery and drive motor have moved relatively to an R side in the vehicle width direction from the state illustrated in FIG. 8; and

FIGS. 11A to 11C are perspective views illustrating yet other embodiments of a support member according to the present invention.

### DETAILED DESCRIPTION OF EMBODIMENTS

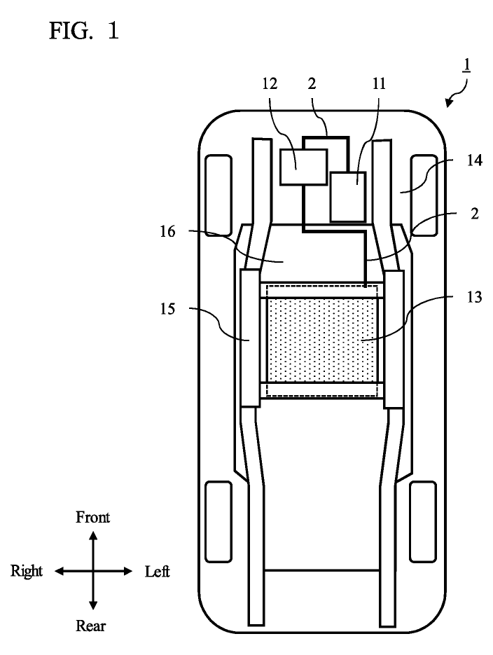

Hereinafter, one or more embodiments of the present invention will be described with reference to the drawings. FIG. 1 is a bottom view of a vehicle illustrating an embodiment of the support structure for a battery wire harness according to the present invention. As illustrated in FIG. 1, a vehicle 1 of the present embodiment has a drive motor 11 as a motor/generator. In the following description, the present invention will be described using an electric automobile that does not have an internal combustion engine and travels solely on the drive motor 11 as an example of the vehicle 1. However, the type of vehicle 1 according to the present invention is not particularly limited, and vehicles according to the present invention include not only electric automobiles that travel solely on the drive motor 11, but also hybrid vehicles that are equipped with both an internal combustion engine and a drive motor 11 and use both as driving sources, and hybrid vehicles that use only the drive motor 11 as a driving source and use the internal combustion engine as a power source for generating electricity.

The vehicle 1 of the present embodiment includes, as a support structure for the battery wire harness, a drive motor 11, a battery 13 that supplies power to the drive motor 11, an inverter 12 that converts DC current from the battery 13 into AC current and converts AC current regenerated by the drive motor 11 into DC current, and a wire harness 2 that transmits and receives power between the battery 13, inverter 12, and drive motor 11.

The drive motor 11 and inverter 12 of the present embodiment are mounted in the front of the vehicle 1, for example, in an engine compartment (or motor compartment) 14, and are fixed to the vehicle body structure that constitutes the engine compartment 14. The battery 13 of the present embodiment is composed of cell modules housed in a battery case, and is fixed to the exterior side (underfloor side) of a floor panel 16 via a battery frame 15. The wire harness 2 is connected between the battery 13 and the inverter 12, and between the drive motor 11 and the inverter 12, to supply high-voltage power from the battery 13 to the drive motor 11 and regenerative power from the drive motor 11 to the battery 13. The wire harness 2 of the present embodiment has a wire portion 21, whose conductor is covered with an insulator, and connector portions 22 provided on both ends of the wire portion 21. The wire harness 2 is connected by attaching the connector portions 22 of the wire harness 2 to respective connector portions provided on the drive motor 11, inverter 12, and battery 13.

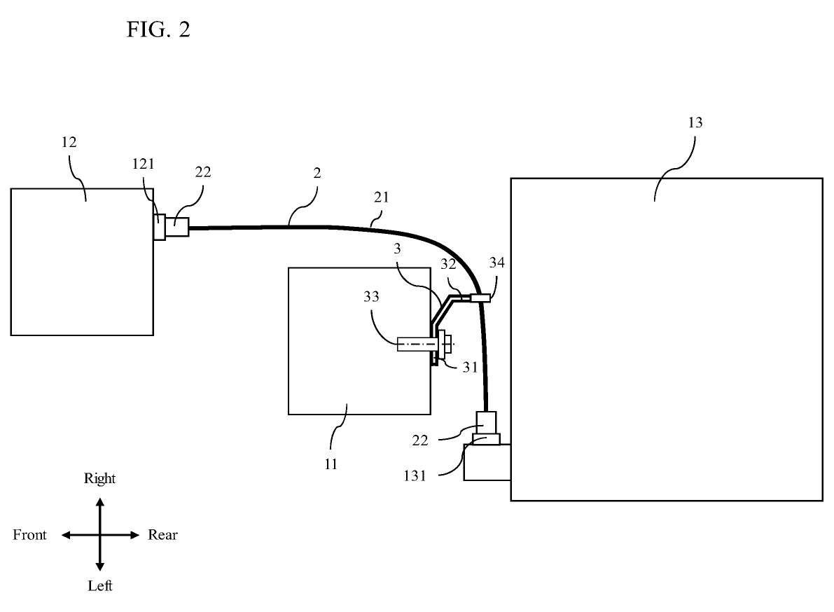

FIG. 2 is a plan view illustrating an embodiment of the support structure for a battery wire harness according to the present invention. The left-right direction of the drawing corresponds to the front-rear direction of the vehicle 1, and the upper-lower direction of the drawing corresponds to the vehicle width direction of the vehicle 1. As described above, the battery 13 is fixed directly or indirectly to the vehicle body structure on the exterior side of the floor panel 16, and the drive motor 11 and inverter 12 are fixed directly or indirectly to the vehicle body structure in the engine compartment 14.

One connector portion 22 of the wire harness 2 is connected to a connector portion 131 of the battery 13, and the other connector portion 22 of the wire harness 2 is connected to a connector portion 121 of the inverter 12. In FIG. 2, the wire harness 2 connecting the drive motor 11 and inverter 12 is not illustrated.

The vehicle 1 of the present embodiment has a support member 3 as a support structure for the battery wire harness, which secures the wire harness 2 to at least one of the battery 13, drive motor 11, and a part of the vehicle 1 other than these battery 13 and drive motor 11. The battery 13, drive motor 11, or a part of the vehicle 1 other than these battery 13 and drive motor 11 is also referred to as a fixation object of the support member 3. Examples of parts of the vehicle 1 other than the battery 13 and drive motor 11 include the inverter 12 and vehicle body structures such as side members and cross members that constitute the underbody. In the embodiment illustrated in FIG. 2, the casing of the drive motor 11 or the like is the fixation object of the support member 3.

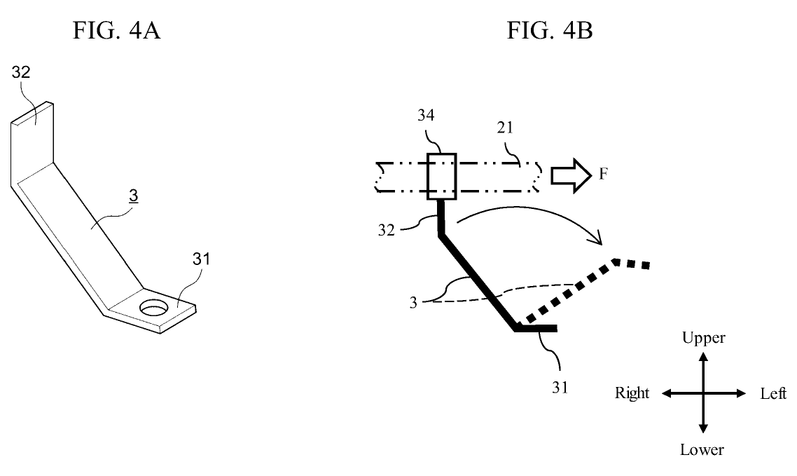

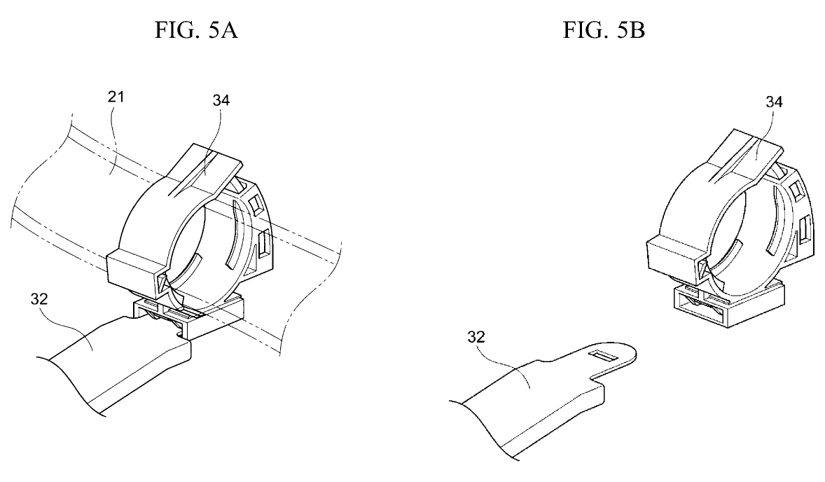

FIG. 4A is a perspective view of an embodiment of the support member 3 according to the present invention, FIG. 4B is a side view, FIG. 5A is a perspective view of an example of a band 34 that secures the wire portion 21 of the wire harness 2 to the support member 3 of FIGS. 4A and 4B, and FIG. 5B is an exploded perspective view. As illustrated in FIGS. 2, 4A, and 4B, the support member 3 of the present embodiment includes a first fixation portion 31 that secures the support member 3 to a fixation object and a second fixation portion 32 that secures the wire portion 21 of the wire harness 2 to the support member 3. The first fixation portion 31 is secured to the drive motor 11 with a fastener 33 such as a bolt, and the wire portion 21 is secured to the second fixation portion 32. As illustrated in FIGS. 5A and 5B, the wire portion 21 is inserted through and fastened to a band 34, and the base end of the band 34 is secured to the second fixation portion 32 of the support member 3 using a ratchet structure or the like.

In particular, the bending strength of the support member 3 in the present embodiment, in response to an input in the vehicle width direction, is set smaller than the tensile strength of the wire portion 21 of the wire harness 2. For example, as illustrated in FIG. 4B, when a force F is input to the wire portion 21 to the left in the vehicle width direction, if this force F exceeds the bending strength of the support member 3, the support member 3 begins to bend first, as indicated by the arrow in the figure, and the wire portion 21 fastened by the band 34 follows the bending movement of the support member 3. This prevents excessive tension from acting on the wire portion 21. This is because the bending strength of the support member 3 against an input in that direction is set smaller than the tensile strength of the wire portion 21.

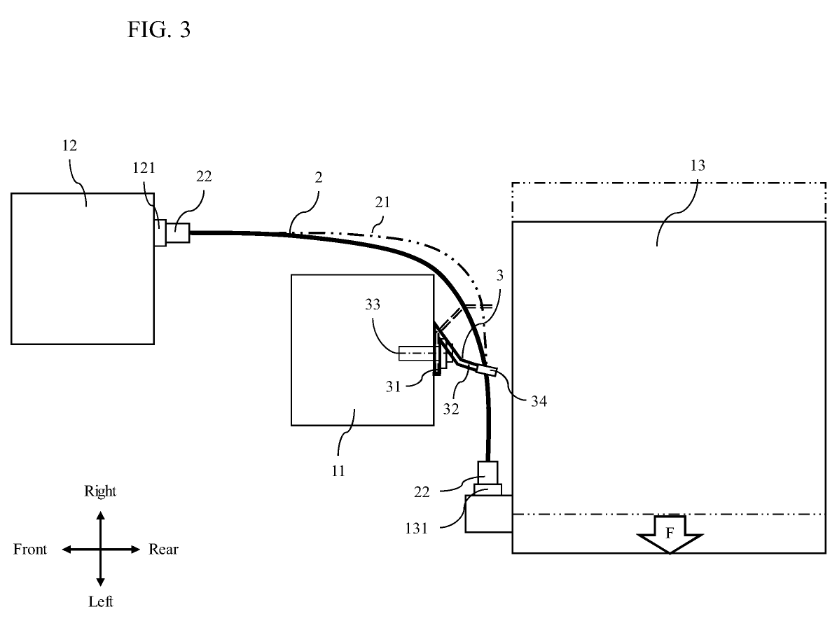

FIG. 3 is a plan view illustrating the state in which the battery 13 and drive motor 11 have moved relatively in the vehicle width direction from the state illustrated in FIG. 2. Here, the state in which the battery 13 has moved to the left (downward in the drawing) as indicated by the outlined arrow is illustrated by a solid line, and the state before the movement is illustrated by a two-dot chain line. When an input F in the vehicle width direction, such as in a side collision, acts on the vehicle 1, the battery 13 and inverter 12 and the drive motor 11 may move relatively farther apart. In this case, as illustrated in FIG. 3, the wire harness 2 connecting the battery 13 and inverter 12 is pulled, which may place an excessive load on the wire portion 21 and/or the connector portion 22.

Fortunately, however, in the support structure for the battery wire harness of the present embodiment, the support member 3, which has one end fastened with the wire portion 21 and the other end secured to the drive motor 11, begins to bend first as the battery 13 and inverter 12 and the drive motor 11 move relatively away from each other, as illustrated in FIG. 3, and the wire portion 21 fastened by the band 34 follows the bending movement of the support member 3. This can suppress excessive tension acting on the wire portion 21 and connector portion 22.

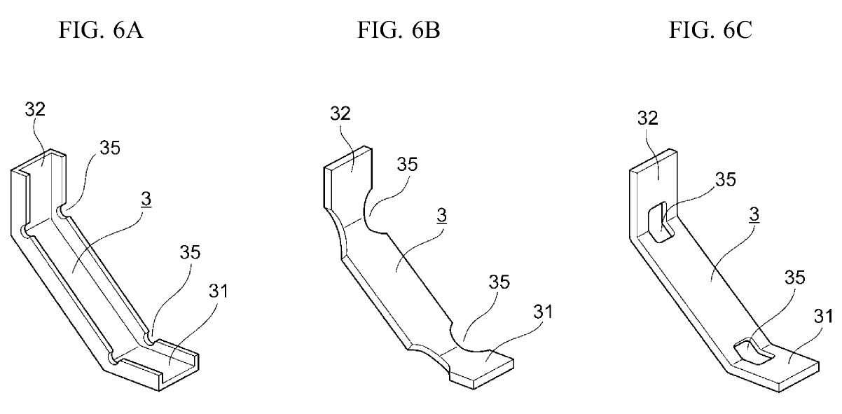

FIGS. 6A to 6C are perspective views illustrating other embodiments of the support member 3 according to the present invention. The support member 3 of the present embodiment bends before excessive tension acts on the wire portion 21 of the wire harness 2 in response to an input in the vehicle width direction, in which case it is more preferred for the support member 3 to have one or more vulnerable sites 35 between the first fixation portion 31 that is secured to the drive motor 11 and the second fixation portion 32 to which the wire portion 21 of the wire harness 2 is secured. The support member 3 illustrated in FIG. 6A is an example in which the vulnerable sites 35 are notches in a flange. The support member 3 illustrated in FIG. 6B is an example in which the vulnerable sites 35 are notches in a flat member main body. The support member 3 illustrated in FIG. 6C is an example in which the vulnerable sites 35 are openings in the member main body.

Providing the support member 3 with one or more vulnerable sites 35 makes it easier to specify the deformation mode, ensuring the durability and fatigue strength of the support member 3 under normal conditions while also allowing for adjustment of bending strength during a collision.

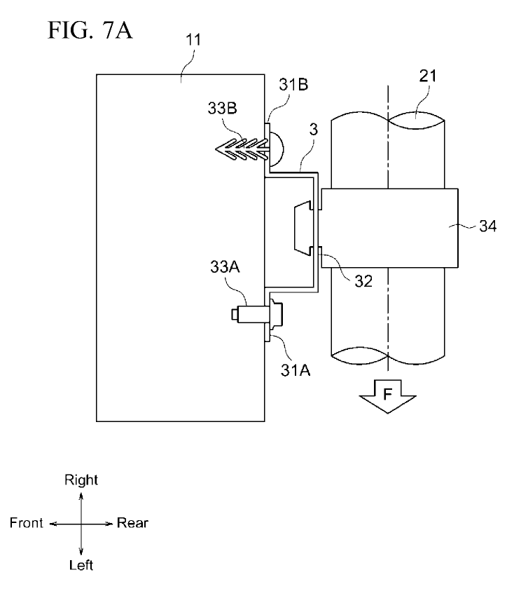

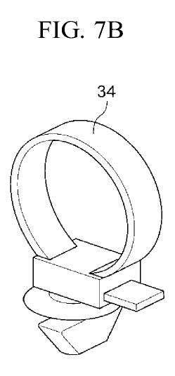

FIG. 7A is a plan view illustrating still another embodiment of the support member 3 according to the present invention, and FIG. 7B is a perspective view illustrating the band 34. While the support member 3 in the embodiment illustrated in FIG. 2 is secured to the fixation object using a single first fixation portion 31, the support member 3 may be secured to the fixation object at two locations to ensure the durability and fatigue strength of the support member 3 under normal conditions.

That is, the support member 3 illustrated in FIG. 7A has two first fixation portions 31A and 31B and one second fixation portion 32. One first fixation portion 31A is secured to the drive motor 11 by a fastener 33A such as a bolt. The other first fixation portion 31B is secured to the drive motor 11 by a fastener 33B such as a clip. The second fixation portion 32 is provided between the two first fixation portions 31A and 31B, and the wire portion 21 is inserted and fastened through the band 34 illustrated in FIG. 7B, and the base end of the band 34 is inserted into and secured in the through-hole of the second fixation portion 32 of the support member 3.

By using different fasteners 33A and 33B for the two first fixation portions 31A and 31B, respectively, the fixation strength of one of the two first fixation portions 31A and 31B is set smaller than the fixation strength of the other first fixation portion 31A. In addition, the fixation strength of one first fixation portion 31B secured by the fastener 33B such as a clip is set smaller than the bending strength of the support member 3 against input in the vehicle width direction. Furthermore, like the support member 3 illustrated in FIG. 2, the bending strength of the support member 3 against an input in the vehicle width direction is set smaller than the tensile strength of the wire portion 21 of the wire harness 2.

Due to such a strength relationship, for example, as illustrated in FIG. 7A, when a force F is input to the wire portion 21 to the left in the vehicle width direction, if this force F exceeds the fixation strength of one fixation portion 31B, the fastener (clip) 33B of one first fixation portion 31B will first come out, then the support member 3 will begin to bend, and the wire portion 21 fastened by the band 34 will follow the bending movement of the support member 3. This prevents excessive tensile force from acting on the wire portion 21. This is because the bending strength of the support member 3 against the input in that direction is set smaller than the tensile strength of the wire portion 21.

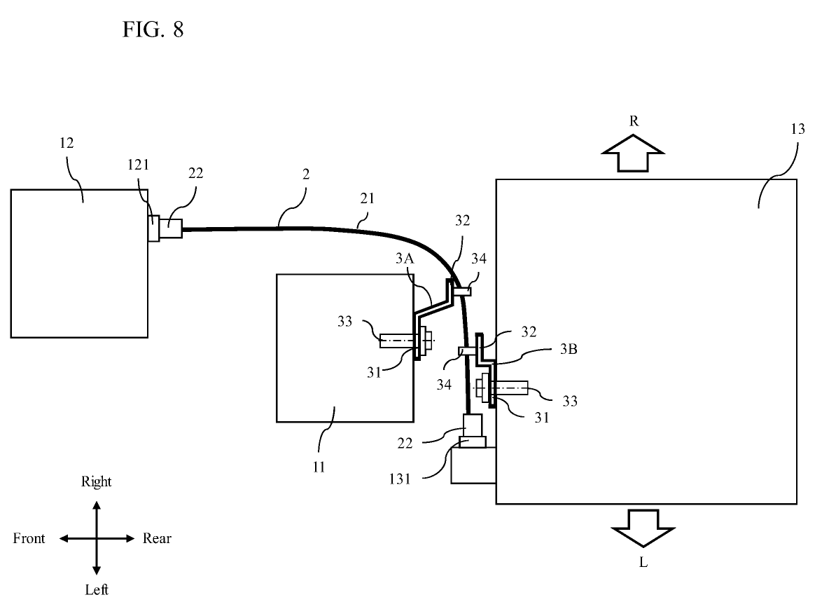

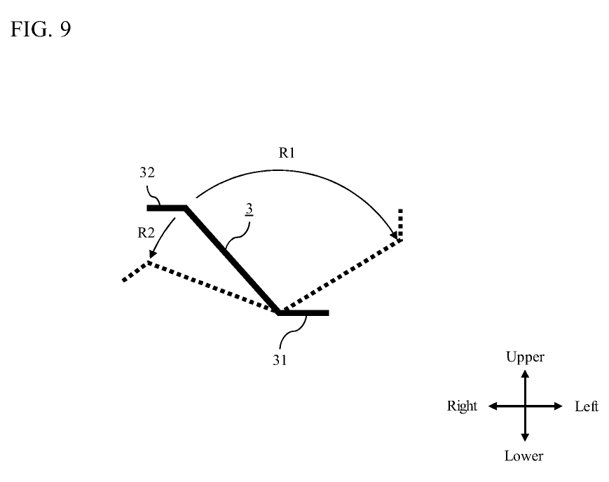

FIG. 8 is a plan view illustrating another embodiment of the support structure for a battery wire harness according to the present invention, and FIG. 9 is a side view for describing a movable range of the support member of FIG. 8. While the embodiment illustrated in FIG. 2 illustrates only one support member 3, a single wire harness 2 may be supported using two or more support members 3, and the two or more support members 3 may be secured to a fixation object.

When a single wire harness 2 is supported by two or more support members 3, although not limited thereto, the support members 3 preferably include a first support member 3A facing the battery 13 and provided on the drive motor 11 (which may otherwise be a part of the vehicle 1 other than these), and a second support member 3B facing the drive motor 11 (which may otherwise be a part of the vehicle 1 other than these) and provided on the battery 13, and the first fixation portion 31 of the first support member 3A and the first fixation portion 31 of the second support member 3B are preferably arranged on the same side in the vehicle width direction as the second fixation portions 32 of the first support member 3A and second support member 3B.

As illustrated in FIG. 9, the support member 3 of the present embodiment has a movable range due to buckling deformation bending in an R1 direction and a movable range due to tensile deformation bending in an R2 direction, but the movable range due to buckling deformation bending in the R1 direction is larger, ensuring a longer movement distance for the wire portion 21. If a force in the vehicle width direction, such as in a side collision, is input and the battery 13 and drive motor 11 move relatively to the L side in the vehicle width direction, as described in FIG. 3, the first support member 3A secured to the drive motor 11 will undergo buckling deformation in the R1 direction illustrated in FIG. 9, thereby ensuring a long movement distance for the wire portion 21. In this case, the second support member 3B will undergo tensile deformation in the R2 direction illustrated in FIG. 9.

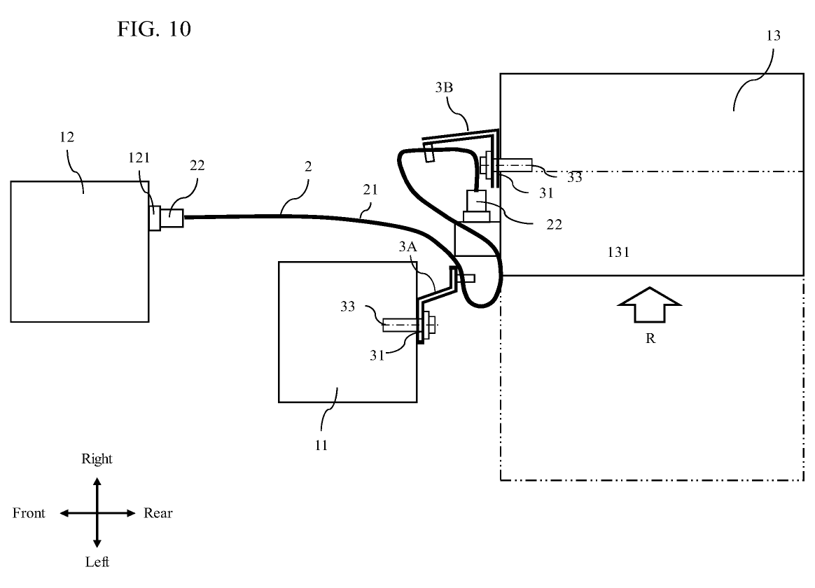

In contrast, if a force in the vehicle width direction, such as in a side collision, is input and the battery 13 and drive motor 11 move relatively to the R side in the vehicle width direction, as illustrated in FIG. 10, the second support member 3B secured to the battery 13 will undergo buckling deformation in the R1 direction illustrated in FIG. 9, thereby ensuring a long movement distance for the wire portion 21. In this case, the first support member 3A will undergo tensile deformation in the R2 direction illustrated in FIG. 9. Thus, the support structure for a battery wire harness according to the present embodiment can suppress excessive tension acting on the wire portion 21 and connector portion 22 in any of the left and right directions in the vehicle width direction.

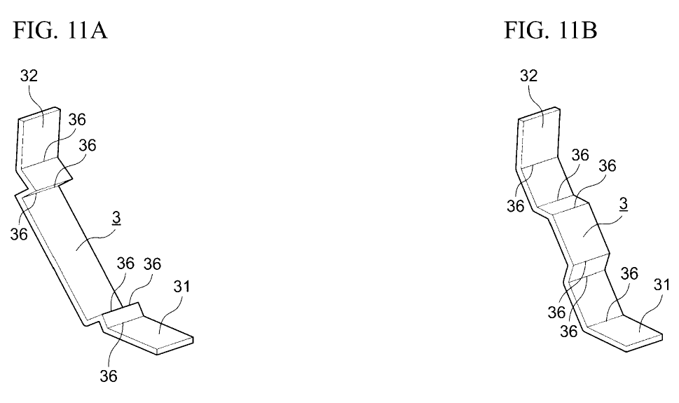

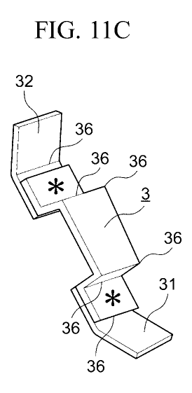

FIGS. 11A to 11C are perspective views illustrating yet other embodiments of a support member according to the present invention. The support member 3 illustrated in FIGS. 4A and 4B is formed in a flat plate shape between the first fixation portion 31 at one end and the second fixation portion 32 at the other end, and has two extension portions 36 folded to be stretchable in response to input in the vehicle width direction, but the support member 3 may be provided with three or more extension portions 36. In the support member 3 illustrated in FIG. 11A, the base portion of the first fixation portion 31 is provided with three extension portions 36, and the base portion of the second fixation portion 32 is also provided with three extension portions 36. When the spacing between the extension portions 36, formed by folding a sheet material, is shortened as in this example, they also serve as vulnerable sites 35.

The support member 3 illustrated in FIG. 11B has one extension portion 36 provided at each of the base portions of the first fixation portion 31 and second fixation portion 32, with two extension portions 36 provided between the first fixation portion 31 and the second fixation portion 32, for a total of four extension portions 36. The support member 3 illustrated in FIG. 11C has the same overall shape and the same number of extension portions 36, but differs in that it is made by joining three sheet materials together. Thus, the support member 3 of the present invention is not limited to being composed of a single component, but may be composed of two or more components.

As described above, the support structure for a vehicle battery wire harness of the present embodiment comprises: a drive motor 11; a battery 13 that supplies power to the drive motor 11; a wire harness 2 that supplies the power from the battery 13 to the drive motor 11; and a support member 3 that secures the wire harness 2 to at least one of the battery 13, the drive motor 11, and a part of a vehicle 1 other than these, wherein a bending strength of the support member 3 against an input in a vehicle width direction is set smaller than a tensile strength of the wire harness 2; therefore, when an input F in the vehicle width direction, such as in a side collision, acts on the vehicle 1 and causes the battery 13, inverter 12, and drive motor 11 to move relatively apart, the support member 3 begins to bend first in response to this movement, and the wire portion 21, which is fastened by the band 34, follows the bending movement of the support member 3. This can suppress excessive tension acting on the wire portion 21 and connector portion 22.

Moreover, in the support structure for a vehicle battery wire harness of the present embodiment, the support member 3 has a vulnerable site 35 between a first fixation portion 31 that is secured to the battery 13, the drive motor 11, or a part of the vehicle 1 other than these, and a second fixation portion to which the wire harness 2 is secured; therefore, it is easy to specify the deformation mode, ensuring the durability and fatigue strength of the support member 3 under normal conditions while also allowing for adjustment of bending strength during a collision.

Furthermore, in the support structure for a vehicle battery wire harness of the present embodiment, the support member 3 is secured at two locations to the battery 13, the drive motor 11, or a part of the vehicle 1 other than these, and a fixation strength of one first fixation portion 31B of first fixation portions 31A and 31B at the two locations is set smaller than a fixation strength of the other first fixation portion 31A and is also set smaller than the bending strength of the support member 3 against the input in the vehicle width direction; when a force F in the vehicle width direction is input to the wire harness 2, if this force F exceeds the fixation strength of one fixation portion 31B, the fastener (clip) 33B of one first fixation portion 31B will first come out, then the support member 3 will begin to bend, and the wire portion 21 fastened by the band 34 will follow the bending movement of the support member 3. This prevents excessive tensile force from acting on the wire harness 2.

In addition, in the support structure for a vehicle battery wire harness of the present embodiment, the support member 3 includes: a first support member 3A facing the battery 13 and provided on the drive motor 11 or a part of the vehicle 1 other than these; and a second support member 3B facing the drive motor 11 or a part of the vehicle other than these and provided on the battery 11, and the first fixation portion 31 of the first support member 3A to the drive motor 11 or a part of the vehicle 1 other than these and the first fixation portion 31 of the second support member 3B to the battery 13 are arranged on a same side in the vehicle width direction as the second fixation portions 32 of the first support member 3A and second support member 3B to the wire harness2; therefore, it is possible to suppress excessive tension acting on the wire portion 21 and connector portion 22 in any of the left and right directions in the vehicle width direction.

Moreover, in the support structure for a vehicle battery wire harness of the present embodiment, the support member 3 has three or more extension portions 36 that are folded so as to be extensible in response to an input in the vehicle width direction; therefore, a longer distance can be followed in response to relative movement between the battery 13, inverter 12, and drive motor 11. As a result, it is possible to suppress excessive tension acting on the wire portion 21 and connector portion 22.

1. A support structure for a vehicle battery wire harness, comprising:
a drive motor;
a battery that supplies power to the drive motor;
a wire harness that supplies the power from the battery to the drive motor; and
a support member that secures the wire harness to at least one of the battery, the drive motor, and a part of a vehicle other than the battery and the drive motor,
wherein a bending strength of the support member against an input in a vehicle width direction is set smaller than a tensile strength of the wire harness.

2. The support structure for a vehicle battery wire harness according to claim 1, wherein
the support member has a vulnerable site between a first fixation portion that is secured to the battery, the drive motor, or a part of the vehicle other than these, and a second fixation portion to which the wire harness is secured.

3. The support structure for a vehicle battery wire harness according to claim 1, wherein
the support member is secured at two locations to the battery, the drive motor, or a part of the vehicle other than these, and
a fixation strength of one of fixation portions at the two locations is set smaller than a fixation strength of the other fixation portion and is also set smaller than the bending strength of the support member against the input in the vehicle width direction.

4. The support structure for a vehicle battery wire harness according to claim 3, wherein
the support member includes:
a first support member facing the battery and provided on the drive motor or a part of the vehicle other than these; and
a second support member facing the drive motor or a part of the vehicle other than these and provided on the battery,
the fixation portion of the first support member to the drive motor or a part of the vehicle other than these and the fixation portion of the second support member to the battery are arranged on a same side in the vehicle width direction as the fixation portions of the first support member and the second support member to the wire harness.

5. The support structure for a vehicle battery wire harness according to claim 1, wherein
the support member has three or more extension portions that are folded so as to be extensible in response to an input in the vehicle width direction.
